(19) United States
(12) Patent Application Publication
(10) Pub. No.: US 2008/0195409 A1
(43) Pub. Date: Aug. 14, 2008

(54) Data processing

(75) Inventor: Philip William Shankland, Sheffield (GB)

Correspondence Address: JAMES C. WRAY, 1493 CHAIN BRIDGE ROAD, SUITE 300, MCLEAN, VA, 22101, US

(73) Assignee: The Hive (Where Bees Make Honey) Limited

(21) Appl. No.: 12/069,543

(22) Filed: Feb. 11, 2008

(30) Foreign Application Priority Data
Feb. 12, 2007 (GB) 07 02 663.6

(51) Int. Cl. G06Q 99/00

(52) U.S. Cl. 705/1

(57) ABSTRACT

Information is submitted over a network that comprises a mobile device and a server. The mobile device obtains an image of a visual symbol. The visual symbol is parsed into a code and a network address of the first server that corresponds to said code is obtained. The address is modified to include an identification of the mobile device and a request is sent to the modified network address. The server receives the request and obtains account details that correspond with the identification of the mobile device.

### TECHNICAL FIELD

The present invention relates to a method of submitting information over a network between a mobile device and a server.

### BACKGROUND OF THE INVENTION

Mobile devices such as telephones are able to browse the Internet using services such as WAP and GSM. However, it is difficult and time-consuming for a mobile telephone user to browse using the slow wireless connection, small screen and limited manual input provided by the device buttons. Further, users are generally billed either by the amount of data consumed or by the time spent online, and thus the longer it takes the more expensive it is. These constraints mean that it is generally not cost-effective to provide and advertise mobile webpages, for example in magazines and on posters, because although users may wish to buy a product or find out more about it they are unlikely to access a webpage while on the move. However, by the time they arrive home, where they can access the Internet more easily and cheaply on their home computers, they are likely to have forgotten their interest in the product.

### BRIEF SUMMARY OF THE INVENTION

According to an aspect of the present invention, there is provided a method of submitting information over a network comprising a mobile device and a first server, comprising the steps of obtaining an image of a visual symbol at the mobile device, parsing the visual symbol into a code, obtaining a network address of the first server that corresponds to the code, modifying the network address to include an identification of the mobile device, sending a request to the modified network address, and at the first server, receiving the request and obtaining account details that correspond with the identification of the mobile device.

### BRIEF DESCRIPTION OF THE SEVERAL VIEWS OF THE DRAWINGS

FIG. 1 illustrates a networked environment in which the invention may be used;

FIG. 2 illustrates an advertisement including photographable tags;

FIG. 3 shows a mobile telephone shown in FIG. 1 photographing a tag shown in FIG. 2;

FIG. 4 shows data transfer processes between mobile devices and servers shown in FIG. 1;

FIG. 5 details steps carried out by the mobile telephone shown in FIG. 4;

FIG. 6 details steps carried out during FIG. 5 to obtain a webpage;

FIG. 7 shows a database held on the routing server shown in FIG. 4;

FIG. 8 details steps carried out by the routing server shown in FIG. 4;

FIG. 9 details steps carried out during FIG. 8 to obtain a code from an image;

FIG. 10 shows a database held on the content server shown in FIG. 4;

FIG. 11 details steps carried out by the content server shown in FIG. 4;

FIG. 12 details steps carried out during FIG. 11 to process an order;

FIG. 13 illustrates the mobile telephone shown in FIG. 4 receiving downloadable product;

FIG. 14 details steps carried out during FIG. 11 to store details of a topic on a webpage; and

FIG. 15 illustrates the webpage altered during steps carried out in FIG. 14.

### DESCRIPTION OF THE BEST MODE FOR CARRYING OUT THE INVENTION

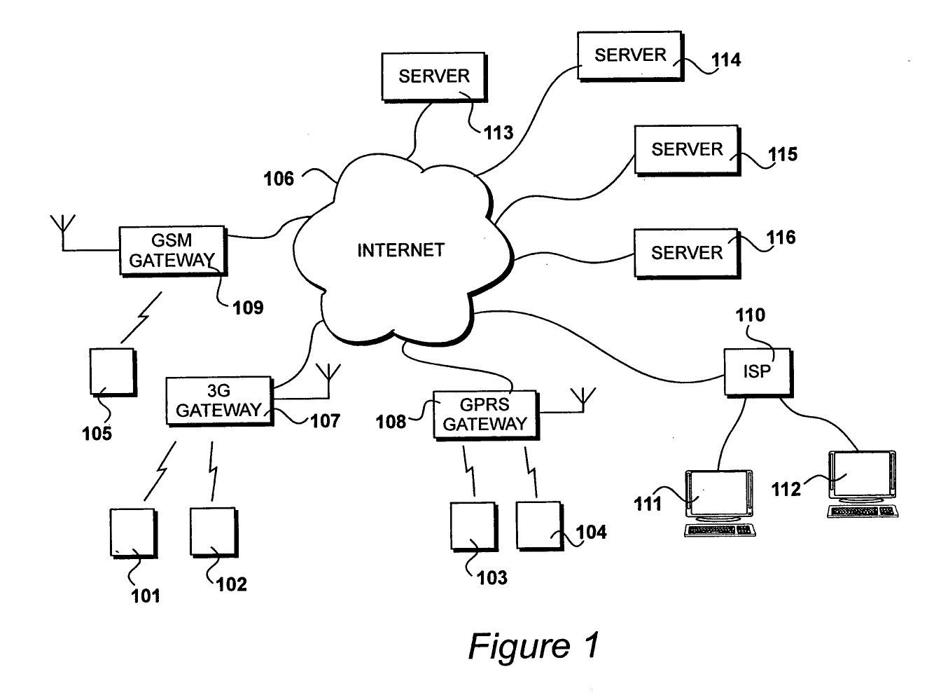

### FIG. 1

FIG. 1 illustrates a networked environment in which the invention may be used. Mobile devices such as mobile telephones 101, 102 and 103 and Personal Digital Assistants (PDAs) 104 and 105 may connect to each other and to the Internet 106 in several ways. A Third Generation (3G) mobile telephony network, connected to the Internet 106, includes a gateway 107 which provides connectivity to a network of base stations. Mobile telephones 101 and 102 are each connected to one of these base stations. A General Packet Radio Service (GPRS) gateway 108 is connected to the Internet 106 and provides connection to a network of GPRS base stations. Mobile telephone 103 and PDA 104 are each connected to one of these stations. A GMS gateway 109 is connected to the Internet 106, providing connectivity for mobile telephone 105.

Computers and servers also connect to the internet. Internet Service Provider (ISP) 110 is connected to the Internet 106 and provides internet access for computers 111 and 112. Web servers 113, 114, 115 and 116 are connected directly to the Internet 106.

Servers 114, 115 and 116 are accessible by any of mobile devices 101 to 105. They provide a number of services, including the sale of physical products such as music, books, DVDs and so on, and downloadable products such as ring tones and wallpaper. In addition, content server 114 also hosts a website, which in this example is a social networking website in which each of a plurality of users maintain a personal page with links to other users' pages and to topics of interest, such as books, music and films. Other servers offering other types of service or product may also be accessed.

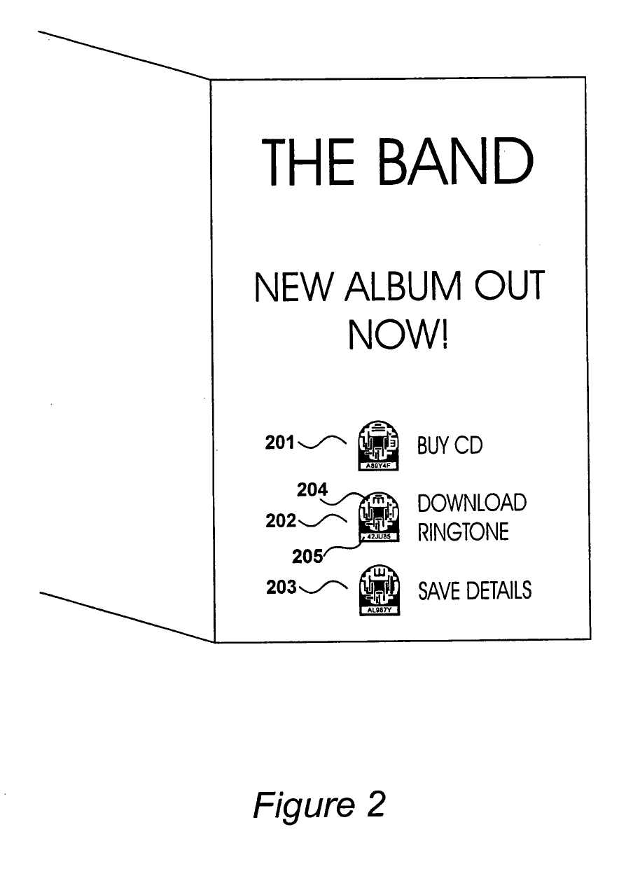

### FIG. 2

It is generally a time-consuming task for the user of a mobile device to browse the websites offered by content servers 114 to 116. The transfer of data over WAP or GSM can be slow, and many devices have small screens and numeric keyboards on which alphabetic input is difficult. Thus visually-readable tags are provided that may be used to assist a user in navigating more quickly to a desired website. FIG. 2 illustrates a page of a magazine advertising an album of music. Three tags are provided, each in the form of a two-dimensional barcode. Accessing the webpage indicated by tag 201 will navigate the user to a page where he may buy the CD, while tag 202 points to a page where he may download the ringtone. Using tag 203, the user can store the album on his profile page of the social networking site hosted by server 114 in order that at a later date he may make a decision as to whether to purchase it.

Each of tags 201 to 203 comprises a circular barcode and a six-digit alphanumeric code. Thus, for example, tag 202 comprises a barcode 204 and an alphanumeric code 205. The barcode 204 comprises shapes from which data bits may be read, and it is designed to be photographed by a digital camera and parsed to provide, in this example, a ten-digit hexadecimal code. The alphanumeric code 205 may be read by optical character recognition software. Thus tags 201 to 203 are suitable for use with mobile devices that include a camera and that may communicate with a server. Mobile telephones are described herein but any device, such as a digital music player, a PDA or another device not yet envisaged, may include a digital camera and means for communicating. The tags shown herein are only examples of symbols that may be used in the present invention. Any symbol that may be photographed and parsed into any type of transmittable code may be used.

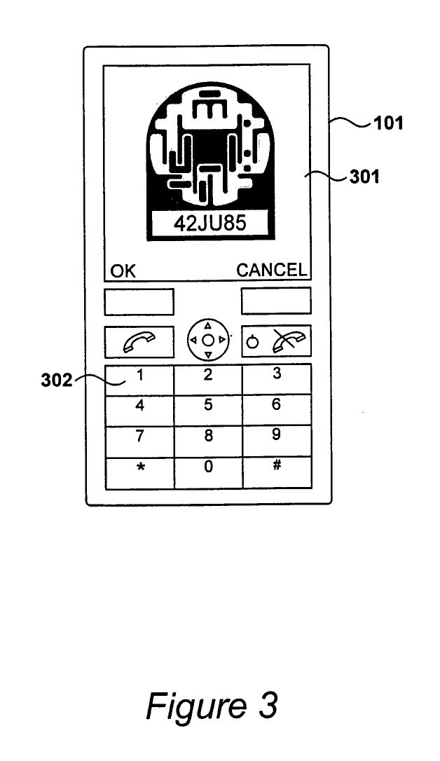

### FIG. 3

FIG. 3 shows mobile telephone 101. The telephone includes an LCD screen 301 and a keypad 302. Mobile telephone 101 has been used to photograph tag 202, since the user wishes to download the ringtone associated with the advertised album.

In this example, mobile telephone 101 is a typical telephone including a processor, flash memory, data storage memory, a battery, input/output means for wired connection to a computer and wireless communication means for communicating with mobile telephone network masts. Using an available mobile telephone network it can communicate with other telephones and can also access the Internet.

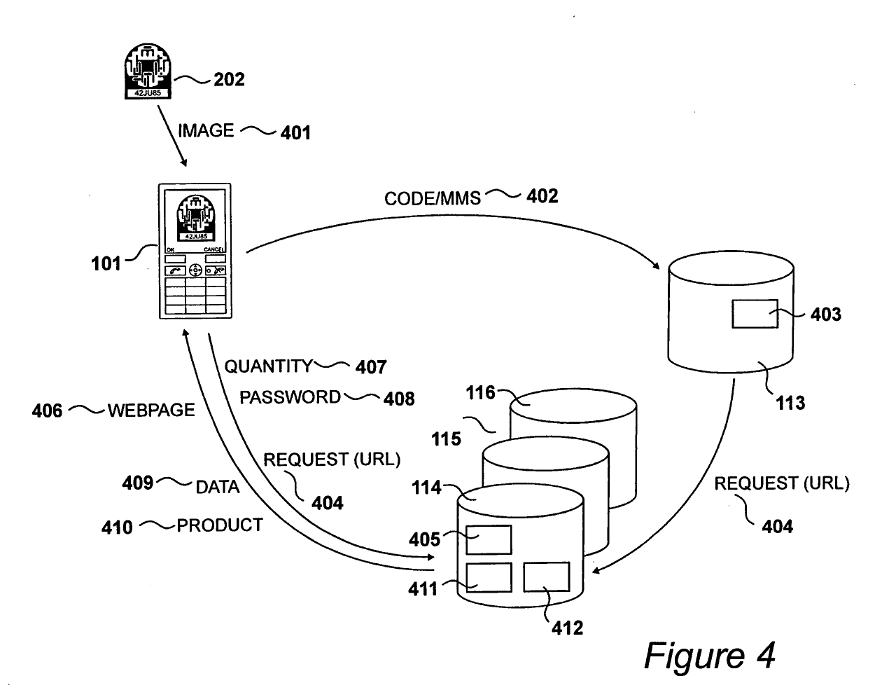

### FIG. 4

As shown in FIG. 4, mobile telephone 101 photographs tag 202 as an image 401 and converts it into a hexadecimal code 402 that it sends wirelessly to server 113. Server 113 is a routing server that provides a link between mobile devices 101 to 105 and content servers 114 to 116. Alternatively, if the user does not wish to use the parsing application or if the mobile telephone 101 is unable to parse the tag 202, the user may send a picture of the tag to routing server 113 using a picture message (MMS). Routing server 113 then parses it to obtain the hexadecimal code 402.

Routing server 113 uses database 403, stored on the server, to convert the code 402 into a URL 404 that identifies an address for information on the relevant content server. It modifies the URL 404 to further include an identification of mobile telephone 101, known as a user ID, and an indication of the product or service required, known as a matter ID. In this example the mobile telephone is identified by the telephone number of its SIM card, its IMEI number and its wireless communication ID (such as Bluetooth®), but only one of these or some other device identification could be used. Although the user ID identifies the mobile telephone, it is for the purposes of identifying the user of the device. The matter ID in this example indicates either a product, whether physical or downloadable, available from one of servers 114 to 116, or a topic to be saved to the social networking website 405 hosted by content server 114.

For example, suppose the URL 404 indicates content stored on content server 114. On receiving a request in the form of URL 404, either from routing server 113 or directly from mobile telephone 101, content server 114 returns a webpage 406 to mobile telephone 101 using the telephone number contained in the user ID. Because the user and the required product or service are identified within the modified URL 404 there is no need for the user to perform further browsing. The user's account is accessed and the required product is selected. Typically, the only information required may be an indication of quantity 407 and the supply of a password 408. Quantity is useful for physical products but less so for data; for example, a user is unlikely to want more than one identical ringtone. Passwords are not essential but provide security for a user should an unauthorized person use his mobile device. However, the password may be extraneous for certain services, for example, when saving of items to the social networking site.

Content server 114 then fulfills the request in one of a number of ways, dependent upon what has been requested by the photographed tag. It may send data 409 to mobile telephone 101, send a product 410 to an address held in a database 411, or alter the user's homepage in the social networking website 405. If a purchase is being made, then content server 114 may require a password 407 to be sent from mobile telephone 101 in order to access payment details held in the database 411. Content server 114 also stores a tracking database 412, which monitors the location of tags that have been photographed and used in the manner herein described.

Content servers 115 and 116 also each include a database of users, possibly having different passwords, user names, credit card and address details from database 411, and a tracking database.

In an alternative embodiment, mobile telephone 101 could access the database on routing server 113 in order to obtain and modify a URL itself, rather than rely on routing server 113 to do this. Also, all communication could be routed through routing server 113 instead of being direct between the content servers and mobile devices.

Thus mobile telephone 101 obtains an image 401 of a visual symbol, in this example tag 202. Either mobile telephone 101 or routing server 113 parses the barcode 204 in tag 202 to a hexadecimal code 402 and obtains the URL 404 corresponding with that code 402. The URL is modified to include an identification of the mobile telephone 101, either by telephone 101 or by routing server 113. A request is sent to this modified URL 403, either by telephone 101 or by routing server 113. The request is received by content server 114, which retrieves, from its database, account details that correspond with the identification of mobile telephone 101.

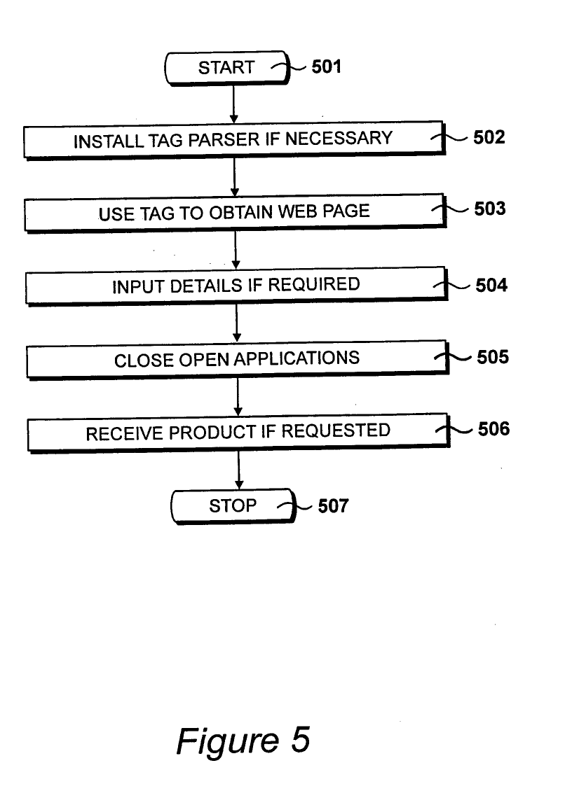

### FIG. 5

FIG. 5 shows the steps carried out by a mobile device such as mobile telephone 101 to use the system described herein. At step 501 the process starts and at step 502 the tag parsing application is installed if necessary, typically as a download. At step 503 the user utilizes a tag, such as tag 202, to access a webpage on a content server, for example content server 114, for the item linked to the tag, and at step 504 any details required by content server 114 are input, such as the quantity of the product required or a password. At step 505 any open applications, such as the tag parsing application and web browsing application, are closed and at step 506 the product is received, if relevant. The process terminates at step 507.

In some cases the user will not be viewing a webpage, since he may only be registering his interest in an item. In this case, an action will be carried out at content server 114 but no webpage will be viewed nor any product returned. However, in other embodiments a confirmatory webpage may be displayed or confirmatory message returned.

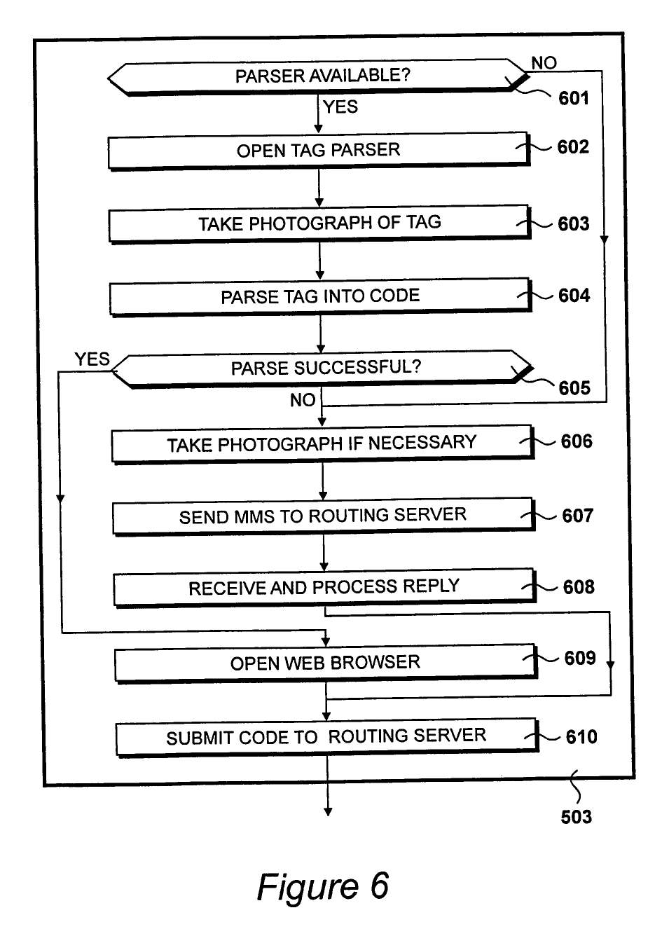

### FIG. 6

FIG. 6 details step 503 at which a tag is used to access a webpage. At step 601 a question is asked as to whether the parsing application is available. If this question is answered in the affirmative then at step 602 the application is opened, which starts the camera on the telephone. At step 603 a photograph of the tag 202 is taken. At step 604 the application attempts to parse the barcode 204 into a ten-digit hexadecimal code. At step 605 a question is asked as to whether this was successful. The application may not be able to parse some images of tags, for example because the resolution is too low (which may particularly happen in bad light), because there is too much glare, because the angle is wrong, and so on. In this case the user may send an image of the tag to routing server 113 by MMS instead of using the parsing application. Further, the user may routinely use MMS rather than install and use the parsing application.

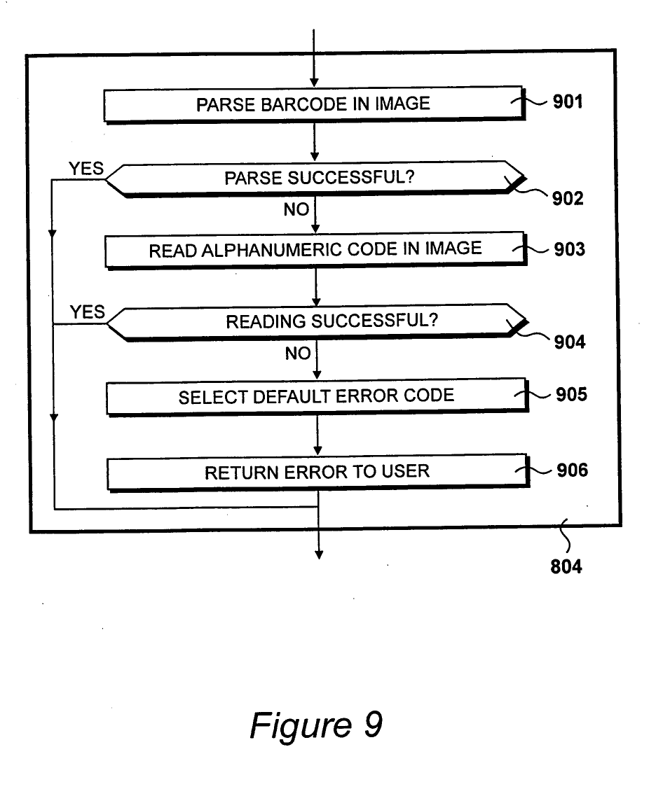

Thus if either the question asked at step 601 or the question asked at step 605 is answered in the negative, to the effect that either the parsing application is not available or the parsing was unsuccessful, a further photograph is taken if necessary at step 606 and at step 607 the photograph is sent via MMS to a specified email address of routing server 113. Routing server 113 parses the received image, as will be described further with respect to FIG. 9, and thus t step 608 a message is received that contains a URL to a webpage, which the user may then access by starting a web browser.

Alternatively, if the question asked at step 605 is answered in the affirmative, to the effect that the tag was successfully parsed by the parsing application, then at step 609 the parsing application opens a web browser application and submits the code to routing server 113 at step 610. The routing server then initiates routines to display the relevant webpage on the browser.

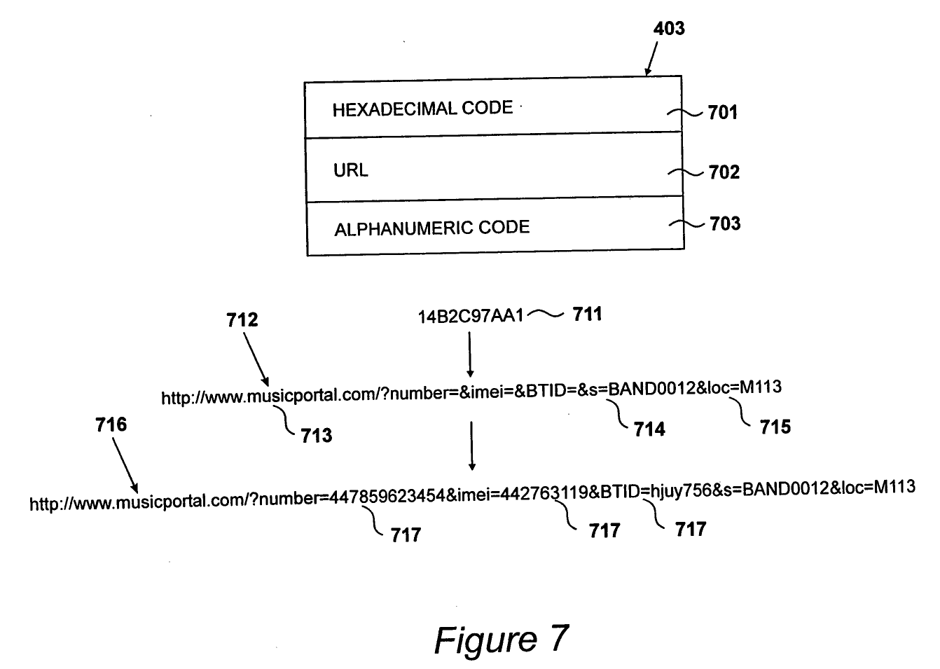

### FIG. 7

FIG. 7 shows database 403 that is held on routing server 113. It maps each hexadecimal code 701 to a URL 702. Thus in the example shown, hexadecimal code 711 is mapped to URL 712 which indicates the server address 713, a matter ID 714 indicating either a product to be bought or a topic to be saved, and a location 715 that corresponds to the magazine shown in FIG. 2. Database 403 also indicates an alphanumeric code 703 associated with each hexadecimal code 701. This is the alphanumeric code on the tag, such as code 205 on tag 202, which can be used to identify the tag if parsing of the barcode 204 is unsuccessful.

URL 712 is modified to URL 716 by the addition of phone number 717, IMEI number 718 and wireless communication ID 719 of mobile telephone 101. These are used by content server 114 to identify the user and to route information. In further embodiments additional information could be included, such as the version number of the parsing application to allow an updated version to be downloaded.

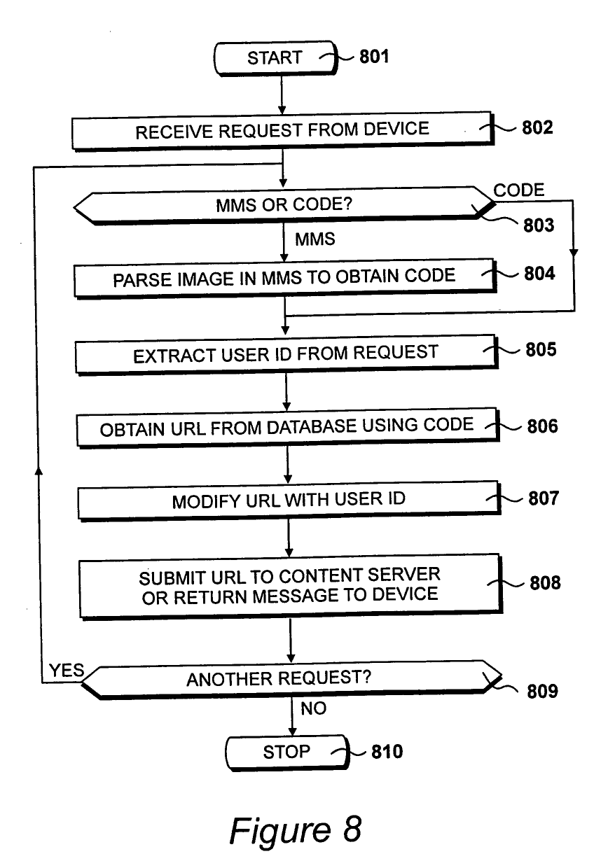

### FIG. 8

FIG. 8 shows steps carried out by routing server 113 to route requests from mobile telephones 101 to 105 to content servers 114 to 116. Routing server 113 and content servers 114 to 116 are in this example typical servers comprising parallel processors with cache memory, main memory, at least one hard drive providing local storage, and network communication means such as ethernet connections.

At step 801 the process starts and at step 802 a request is received from a mobile device such as mobile telephone 101. At step 803 a question is asked as to whether the request contains a code or an MMS. If the answer to this question is that it is an MMS, then at step 804 the image in the message is parsed to identify the hexadecimal code, as will be described further with respect to FIG. 9.

At step 805 the user ID is extracted from the request and at step 806 the URL corresponding to the hexadecimal code (either received or identified) is obtained from field 702 of database 403 by looking up the code in field 701. At step 807 the URL is modified with the user ID as shown in FIG. 6.

At step 808 the modified URL is submitted to the server having the address indicated in the URL at 613, which in this example is content server 114, if the request was in the form of a code, or if it was an MMS then a message containing the URL is sent back to the telephone 101 using the telephone number that is part of the user ID. This allows the user to start a web browser on the telephone and access the webpage (this is known as a WAP push) At step 809 a question is asked as to whether another request has been received and if this question is answered in the affirmative control is returned to step 803 and the request is processed. Alternatively, the process stops at step 810.

Thus the routing server 113 receives, modifies and routes requests from mobile devices to content servers in order that a content server may fulfill the requests, for example by returning data to the device, dispatching a product to the owner of the device or modifying the user's homepage on a social networking site.

### FIG. 9

If the user wishes to send an image of the tag via MMS to the routing server 113, as described with reference to step 607, then the question asked at step 803 is answered “MMS” and the image is parsed at step 804. This may also happen if the parsing application on the mobile telephone 101 is unable to parse a barcode, in which case it may be that the routing server 113 is able to do so instead since the server can run many more iterations than the telephone, which has memory and power limitations. At step 901 an attempt is made to parse the barcode 204 into a ten-digit hexadecimal code, and at step 902 a question is asked as to whether this has been successful. If this question is answered in the negative then at step 903 an attempt is made to read the alphanumeric code 205, and at step 904 a question is asked as to whether this has been successful. If this is also answered in the negative then the routing server has been unable to read the tag, and thus at step 905 a default error code is selected for forwarding to content server 114 along with the image. This code will prompt content server 114 to save the image of the tag to the user's homepage on the social networking site 405, or if the user has no homepage, to a guest account. At step 906 an error message is returned to the user indicating that the reading of the tag was unsuccessful but that the image has been saved. The user may then view it at a later date to remind himself of what he wished to do when he photographed the tag.

Alternatively, if either of the questions asked at step 902 or step 904 is answered in the affirmative, the tag has been successfully read and a code obtained. Whatever code is obtained, whether the hexadecimal or alphanumeric code corresponding to the tag, or an error code, it is used at step 806 to look up a URL in database 403. This URL is then modified with the user ID and used to direct the request to the relevant content server.

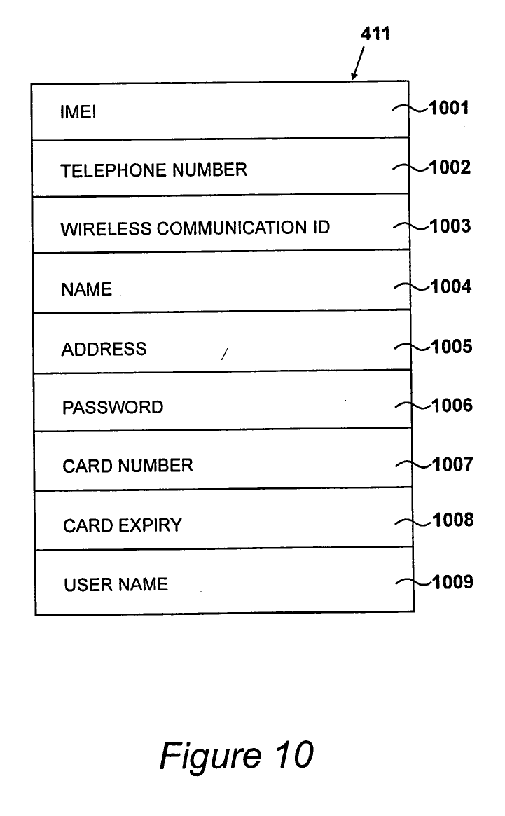

### FIG. 10

FIG. 10 shows database 411 that is held on content server 114. Content servers 115 and 116 store similar databases. For each device that is known to the server, a set of account details is held. Thus database 411 contains fields for the user ID made up of the IMEI 1001, the telephone number 1002 and the wireless communication ID 1003. Also stored are the name 1004 and address 1005 of the user, the password 1006 set up on the account, a credit card number 1007 and expiry date 1008, and finally the user name 1007 that the user uses when accessing the social networking website 405, if relevant. Since the user ID is made up of three parts, it is still possible to identify a user if one part changes. For example, if the user has changed his device and wireless communication ID but kept his telephone number, only part of the user ID will match. In this case content server 114 will initiate an identity-confirmation routine to update the details on the database. Another reason for using a multipart user ID is that in certain circumstances it may not be possible to use the telephone number to identify the user, dependent upon local data protection restrictions, and so the IMEI number, although it will change with each device, can be sufficient.

Thus upon receipt of a modified URL, such as URL 613, content server 114 is able to extract the user ID, either whole or in part, and use it to find account details for the owner of that mobile device. Combined with the matter ID, this means that the user can be immediately provided with or directed to the relevant webpage for the product, and confirm a purchase with very few button presses. Typically, the user will be required to input the password 1006 and confirm the quantity required. This is in contrast with the normal method of having to browse to a website, find the product and input the name, address and payment details, all using the alphanumeric pad 302 which may require several button presses per letter.

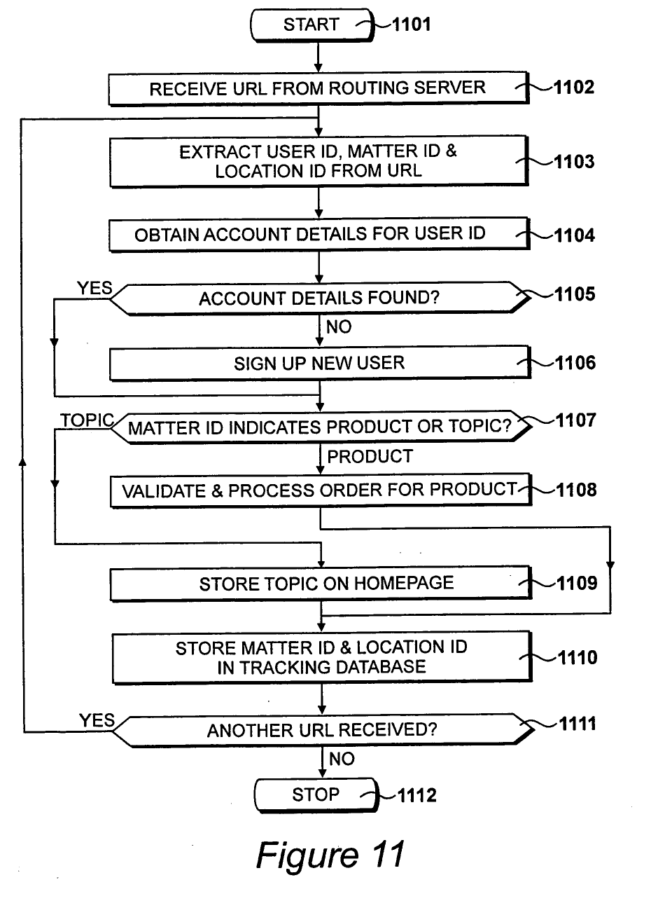

### FIG. 11

FIG. 11 details the process carried out on content server 114 to process communications from routing server 113. Content servers 115 and 116 run similar processes. At step 1101 the process starts and at step 1102 a request in the form of a URL, such as URL 404, is received from routing server 113. At step 1103 the user ID, matter ID and location ID are extracted from the URL and at step 1104 account details for the user ID are obtained from database 411.

At step 1105 a question is asked as to whether these account details have been found and if this question is answered in the negative the user has not used this service before and is signed up online at step 1106. Following either this or an answer in the affirmative to the question asked at step 1105, a question is asked at step 1107 as to whether the matter indicated by the matter ID is a product or a topic. In other words, is this a product that the user wishes to purchase or a topic that he wishes to register interest in? If the answer to the question is “PRODUCT” then at step 1108 the order is validated and processed, while if the answer is “TOPIC” the topic is stored on his social networking webpage at step 1109. If the code relates to an unsuccessful tag parsing at step 804 then routing server 113 also sends the image of the tag. This type of code is considered to be a topic, and thus the image is stored on the homepage during this step.

At step 1110 the matter ID and location ID are stored in tracking database 412. This database allows controllers of the system to audit the efficiency of certain advertisements. Thus, the same product could be represented by different tags depending on where the tag is located, such as in a particular magazine or newspaper, on a poster, on a website, and so on. This information is helpful when deciding where to place further adverts.

At step 1111 a question is asked as to whether another request has been received and if this question is answered in the affirmative control is returned to step 1103 and it is processed. Alternatively the process stops at step 1112.

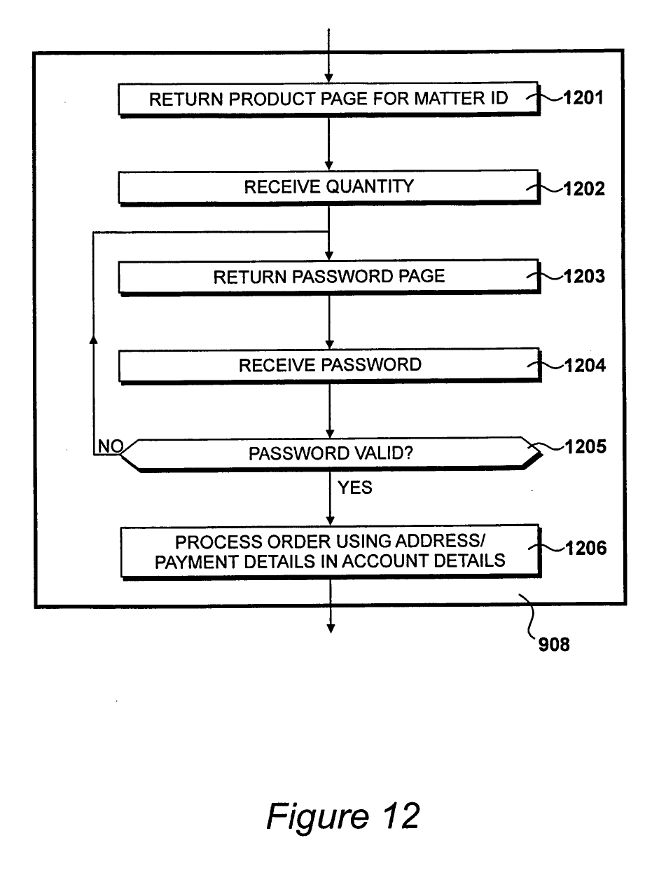

### FIG. 12

FIG. 12 details step 908 at which a product order is validated and processed. At step 1201 the webpage stored on content server 114 that corresponds to the matter ID is returned to the requesting mobile device. Thus, for example, it may be a page where the user can buy the CD advertised in FIG. 2, or a page where the user may download the ringtone, and so on. At step 1202 the user indicates the quantity that he wishes to purchase. At step 1203 a page requesting the user's password is returned to the device using the identified telephone number, and at step 1204 a password is received. At step 1205 a question is asked as to whether this password matches the password held in the account details of database 801 and if this question is answered in the negative then control is returned to step 1203 and the password is requested again. Alternatively, if it is answered in the affirmative, then the order is processed using the address and payment details retrieved at step 904. The exact nature of the processing depends on whether the product is a data download, an item to be posted, or a product requiring some other method of delivery.

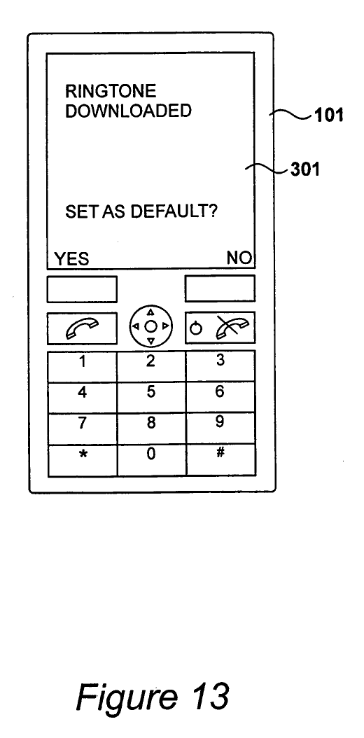

### FIG. 13

FIG. 13 illustrates mobile telephone 101 at the end of step 510 after photographing tag 202 to download a ringtone. As shown on display 301, the download has been received and the user is being prompted to save it as the default ringtone. Alternatively, if a product has been posted out a confirmation message is sent with a predicted delivery date.

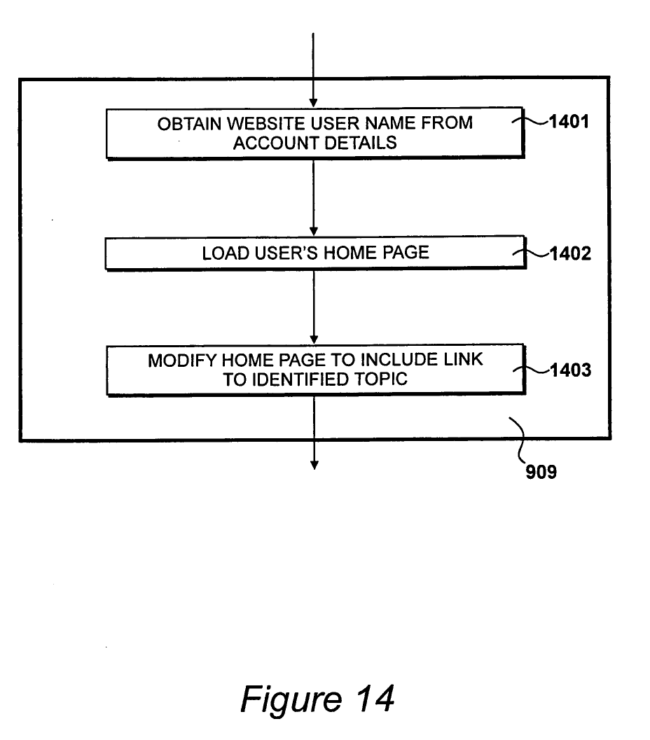

### FIG. 14

FIG. 14 details step 909 at which a topic is stored on the user's homepage in the social networking website 405 held on content server 114. At step 1401 the website user name is obtained from the account details and at step 1402 the code, for example HTML, for the user's homepage is loaded. At step 1403 the home page is modified to include a link to the identified topic. This may be a click-through to a page about the topic, a reminder that the user expressed an interest in the topic, an image of an unparsed tag, and so on.

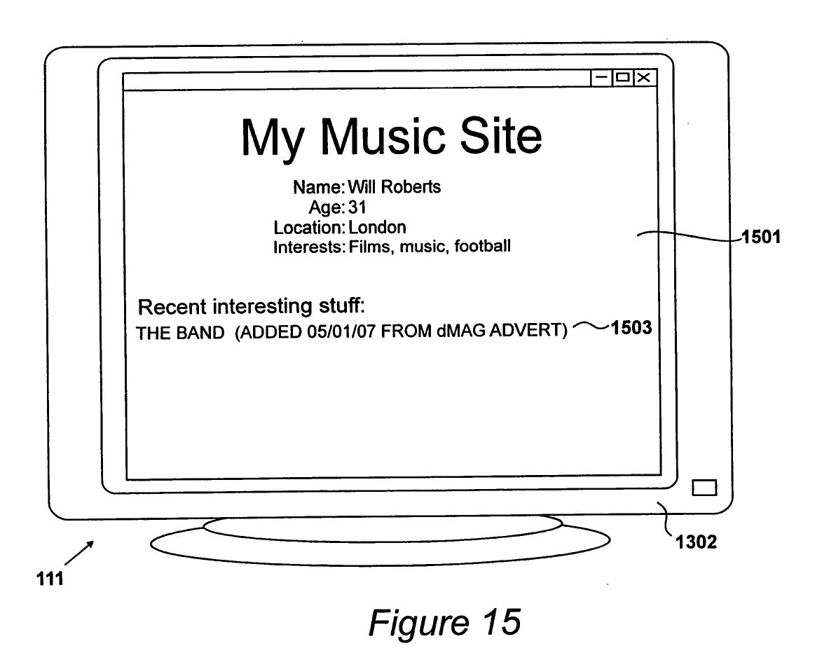

### FIG. 15

The user of mobile telephone 101 is also the user of computer 111 which connects to internet 106 via ISP 110. FIG. 15 illustrates a web browsing application 1501 displayed on the monitor 1502 of computer 111. The user's homepage of the social networking website 405 is shown and as can be seen an indication has been added at 1503 of the band advertised in FIG. 2, with information about the date on which the user added it and the location.

1. A method of submitting information over a network comprising a mobile device and a first server, comprising the steps of:
at said mobile device, obtaining an image of a visual symbol;
parsing said visual symbol into a code;
obtaining a network address of said first server that corresponds to said code;
modifying said network address to include an identification of said mobile device;
sending a request to said modified network address; and
at said first server, receiving said request and obtaining account details that correspond with said identification of said mobile device.

2. A method according to claim 1, wherein said address of said first server is stored on a second server.

3. A method according to claim 2, wherein said step of parsing said visual symbol into said code is carried out on said mobile device.

4. A method according to claim 3, wherein said step of obtaining a network address comprises the steps of:
at said mobile device, establishing a link with said second server; and
at said second server, interrogating a database to determine said address.

5. A method according to claim 3, wherein said step of obtaining a network address comprises the steps of:
at said mobile device, establishing a link with a database on said second server; and
at said mobile device, interrogating said database to determine said address.

6. A method according to claim 2, wherein said step of parsing said visual symbol into said code is carried out at said second server.

7. A method according to claim 6, including the step of sending a multimedia message (MMS) containing said image from said mobile device to said second server.

8. A method according to claim 6, wherein:
said step of parsing said visual symbol into a code comprises identifying a condition to the effect that said visual symbol cannot be parsed;
said step of obtaining a network address of said first server comprises identifying a default network address of a website hosted on said first server in response to said identified condition;
said request includes said image of said visual symbol; and
said account details include a username for said website;
and said method further includes the step of:
storing, at said first server, said image on said website such that it can be accessed using said username.

9. A method according to claim 2, wherein said step of modifying said network address is carried out at said second server.

10. A method according to claim 2, wherein said step of sending a request to said modified network address is carried out at said second server.

11. A method according to claim 2, further including the step of sending said modified network address from said second server to said mobile device, and wherein said step of sending a request to said modified network address is carried out at said mobile device.

12. A method according to claim 1, wherein said visual symbol comprises a two-dimensional barcode.

13. A method according to claim 1, wherein said visual symbol comprises an alphanumeric code.

14. A method according to claim 1, wherein said network address of said first server is a universal resource locator (URL).

15. A method according to claim 1, wherein said mobile device includes a camera and said image is obtained using said camera.

16. A method according to claim 1, wherein said mobile device is a telephone, and said identification of said mobile device comprises the IMEI number of the telephone.

17. A method according to claim 1, wherein said mobile device is a telephone, and said identification of said mobile device comprises the number of said telephone.

18. A method according to claim 1, wherein said network address includes an indication of a product.

19. A method according to claim 18, wherein said account details include a stored password and stored payment information, further including the steps of:
at said mobile device, inputting a password;
transmitting said password to said first server;
at said first server, determining a condition to the effect that the input password matches said stored password; and
creating an order for said product using said stored payment information.

20. A method according to claim 18, wherein each of a plurality of network addresses that include the same indication of a product corresponds to one of a plurality of visual symbols and includes an indication of the location of the corresponding visual symbol.

21. A method according to claim 1, wherein said network address includes an indication of a topic of interest and said account details include an indication of a webpage, further including the step of:
modifying said webpage to include information that includes said indication of said topic of interest.

22. A method according to claim 21, wherein said information comprises a second network address.

23. A server comprising a processor, memory, data storage, and network communication means, wherein said processor is configured to route requests for information by performing the steps of:
receiving an image of a visual symbol from a mobile device;
obtaining a network address of a further server using said image;
modifying said network address to include an identification of said mobile device; and
sending a request to said modified network address.

24. A server according to claim 23, wherein said visual symbol comprises a two-dimensional barcode.

25. A server according to claim 23, wherein said visual symbol comprises an alphanumeric code.

26. A server according to claim 23, wherein the processor is configured to perform the step of obtaining a network address by:
parsing said visual symbol into a code; and
identifying a network address that corresponds to said code.

27. A method according to claim 26, wherein the processor is further configured to perform the step of obtaining a network address by:
identifying a condition to the effect that said visual symbol cannot be parsed; and
identifying a network address of a website hosted by said further server in response to said identified condition;
and wherein said request includes said image of said visual symbol.

28. A server according to claim 27, wherein said network address of said first server is a universal resource locator (URL).

29. A server according to claim 27, wherein information mapping a plurality of said codes to a plurality of said network addresses is stored in said storage.

30. A server according to claim 23, wherein said image is received as a multimedia message (MMS).

31. A server according to claim 23, wherein said identification of said mobile device comprises a telephone number.

32. A server according to claim 23, wherein said network address includes an indication of a product.

33. A server according to claim 32, wherein each of a plurality of network addresses that include the same indication of a product corresponds to one of a plurality of visual symbols and includes an indication of the location of the corresponding visual symbol.

34. A method according to claim 23, wherein said network address includes an indication of a topic of interest.
